(19) United States
(12) Patent Application Publication
(10) Pub. No.: US 2017/0340981 A1
(43) Pub. Date: Nov. 30, 2017

(54) CONSTRUCTION TOY WITH INTERLOCKING ELEMENTS

(71) Applicant: Gavriel Iliovits, Outremont (CA)

(72) Inventor: Gavriel Iliovits, Outremont (CA)

(21) Appl. No.: 15/599,678

(22) Filed: May 19, 2017

Related U.S. Application Data
(60) Provisional application No. 62/343,208, filed on May 31, 2016.

(51) Int. Cl. A63H 33/08; A63H 33/12; F16B 5/07

(52) U.S. Cl. CPC A63H 33/084; F16B 5/07; A63H 33/08; A63H 33/12

(57) ABSTRACT

The present invention relates to a construction toy with interlocking tile-shaped pieces. Each tile-shaped piece has at least two interlocking elements on each side. One element is a male mating portion and the other is a female mating portion, so that each side of any tile-shaped piece is hermaphroditic in relation to any side of another piece, and the pieces can be locked to each other to form a two-dimensional and three-dimensional construction. The tile-shaped pieces must be oriented in the same plane for the interlocking elements to lock. Each interlocking element has a sphere-shaped configuration on a cylindrical stem that is connected to the side of the tile-shaped piece. The male mating portion has a convex configuration as a function of the interlocking element's spherical shape, and the female mating portion is a concavity in the interlocking element that mates with the male portion to lock interlocking elements together.

The present invention relates to a construction toy apparatus that permits a child to build a wide variety for building structures. The toy permits easy, affirmative joining of construction pieces to build a wide variety of structures to stimulate a young child's imagination.

Frequently, tile-based construction toys are limited by the fact that one side is always male and the other is always female. It is the object of the present invention to offer hermaphroditic tiles that can be joined no matter the orientation of the tile.

### BACKGROUND

It is generally accepted knowledge that the earlier neural pathways are formed, the quicker a person can learn more sophisticated skills relating to those pathways. For example, the difference between starting to practice the violin at the age of 4 rather than 8 is more remarkable than the difference between the age of 8 and 12.

The present invention allows curious young minds to expand their imagination. The construction tiles of the present invention can be used to build two-dimensional and three-dimensional structures due to the fact that each tile has interlocking elements around its periphery. The unique joining means between tiles of the present invention results in creations that can comprise an even or odd number of tiles. The tiles will lock together notwithstanding their shapes. For example, a pentagon tile can be joined to five triangle tiles, that will all join together to form a five-sided pyramid. This is due to the fact that the present invention's interlocking elements are hermaphroditic on each side.

There is known U.S. Pat. No. 8,187,050 for “Toy-Building Elements Having Sidewall Grooves Formed Between Outwardly Extending Flexible Ridges” relating to construction elements that can interact with any other elements regardless of their gender. However, there is no hinge-type or axial locking feature, and once locked the elements cannot pivot to suit a child's construction objective.

There is known U.S. Pat. No. 6,301,747 for “Resilient Hinge Connection and CD Holder Box or Photograph Frame Utilizing the Same”, which is sold as a toy for children called “Clics”. The square tiles of this invention have alternating male and female connectors around the periphery that snap together to form two and three-dimensional structures. However, this patent is inferior to the present invention due to the fact that resulting structures can have only an even number of tiles, since a male side will not mate with a male side. The child has to keep track of how adjacent tiles are related in order to build a successful structure. The present invention has both a male and female connector on each side, making the orientation relationship between adjacent tiles irrelevant.

There is known U.S. Pat. No. 3,597,874 for “Releasably Interlocking Units Having a Snap Connection” that describes a toy construction set with connectable members. In the embodiment described on FIG. 4 of this patent, the interlocking members have opposed concave recesses permitting the end portion of one unit to snap between a pair of end portions on another unit. The only similarity between the present invention and cited patent resides in the fact that there is a mating between a concave and convex surface. However, the cited patent has two elements sandwiching one opposing element, thus requiring a minimum of three elements, whereas the locking feature of the present invention necessitates a minimum of four elements, two on each side. In addition, as described on FIG. 4 of the cited patent, the units cannot be locked together in the same plane as tiles of the present invention, and require a turn of 90° between each unit.

There is also known U.S. Pat. No. 6,109,997 for “Toy Building Set Comprising a Number of Transmission Elements” describing toothed wheels with four spokes that can intercooperate with spokes of other toothed wheels due to the fact that the convex abutment surfaces are the same as the concave abutment surfaces of the neighboring wheels. However, this invention is for building more sophisticated constructions such as cars, cranes and machines that require a variety of gear functions. Said wheels are not tiles for building 2D and 3D structures, and are not safe for children under the age of 4.

Finally, there is known U.S. Pat. No. 6,925,770 for “Interlockable Element for Structure Assembly Set” comprising a tile with interlocking elements around its periphery. Each element comprises a plurality of prongs that cooperate with prongs on neighboring tiles to lock said tiles together in various angles. Each tile of cited patent has 24 prongs that cooperate with adjacent prongs by bending slightly out of position and snapping back. This patent is more complicated than the present invention, and a tile of cited patent will be useless if one of the 24 flimsy prongs should break.

The advantages of this invention over all prior art is that it offers both axial rotatability of the formed joint like a hinge, and the ability to join any side to any other side notwithstanding the side's gender. This means that a child can make structures with odd or even number of tiles, without boundaries set by gender-specific joining systems.

### Object of the Present Invention

The present invention is designed to safely stimulate the imagination of a child and offer a great flexibility of potential creations without inherent limitations. Tiles will always cooperate with each other, notwithstanding their geometry and connection gender. The child will be able to build structures in two and three dimensions, and the parent will be able to start stimulation of the child's cognitive and spatial relativity skill sets at an early age.

This invention's blocks or tiles with interconnecting elements on each periphery securely lock said tiles together, permitting a child to build structures. Said tiles also have receiving cavities in their centers for being joined together using elongated connectors, adding a dimension of connectability to the invention's experience. These elongated connectors allow the tiles to rotate around the axis so that if the child builds a model of an animal, this rotation simulates how a head turns on a body.

### BRIEF DESCRIPTION OF THE DRAWINGS

FIG. 1 shows the preferred embodiment of the present invention.

FIG. 2 shows another embodiment of the present invention.

FIG. 3 shows other embodiments of the present invention.

FIG. 4 shows elongated connectors for expanding structures.

FIG. 5 shows a three-dimensional structure made with the present invention.

FIG. 6 demonstrates attachment of an elongated connector.

FIG. 7 shows a two-dimensional structure made with the present invention.

FIG. 8 shows a variant on location of connecting means.

FIG. 9 shows another embodiment of the present invention.

FIG. 10 shows interlocking means of the embodiment of FIG. 9.

FIG. 11 shows another interlocking means of the embodiment of FIG. 9.

FIG. 12 shows yet another interlocking means of the embodiment of FIG. 9.

FIG. 13 shows still another interlocking means of the embodiment of FIG. 9.

FIG. 14 shows an expanding means to customize elongated connectors of FIG. 4.

FIG. 15 shows a construction of a bird made with the present invention.

FIG. 16 shows an expanded view of FIG. 15.

### DETAILED DESCRIPTION OF THE PREFERRED EMBODIMENT

The present invention refers to a child-friendly safe interlocking building block or tile system for constructing two- and three-dimensional structures. The interlocking feature of the present invention comprises cooperation between a novel interlocking element system, wherein male and female portions lock together in a lattice format.

Due to the fact that each side's interlocking means are hermaphroditic, the possibilities of intercooperation between tiles are more numerous than if a tile's side were only male or only female. Notwithstanding the geometric shape of adjacent tiles, their sides will click or join together. The added feature of the interlocking means being similar to hinge knuckles allow rotation of one tile with relation to another, permitting a wide range of structures only limited by the imagination.

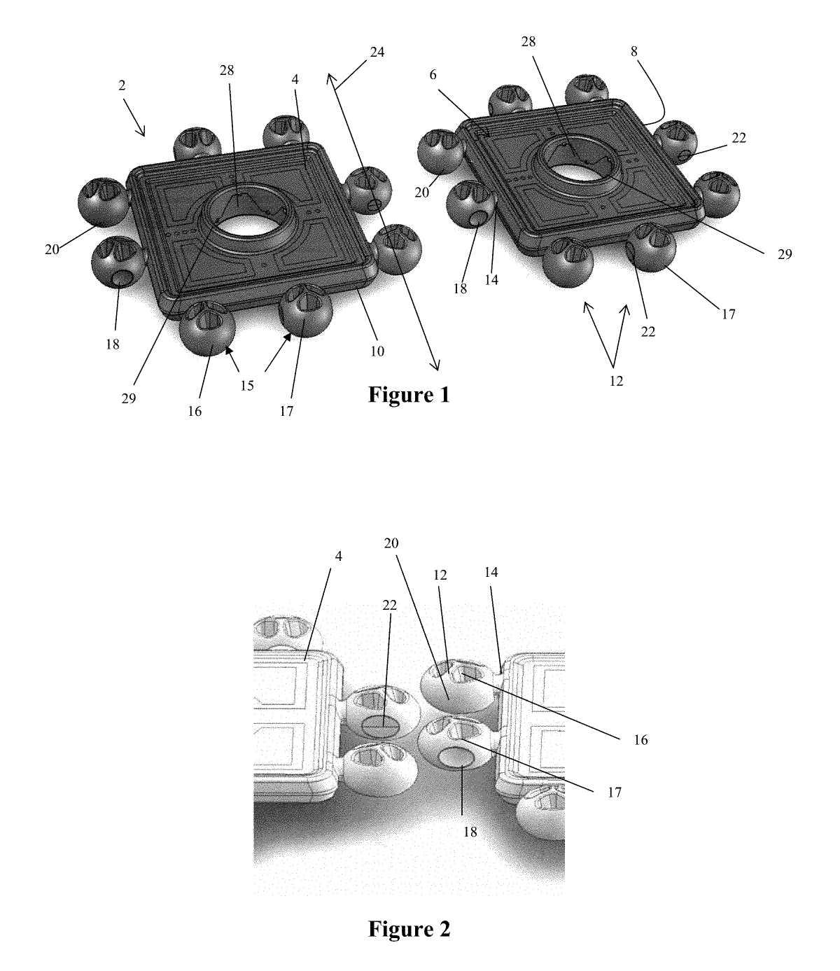

Referring now to drawings, FIG. 1 shows the preferred embodiment of the present invention, namely construction tile 2. Tile 2 is substantially square and flat. Tile 2 comprises square body 4 with a top portion 6, bottom portion 8, and tile periphery 10. Interlocking elements 12 protrude from periphery 10, and each element 12 comprises cylindrical stem 14 that connects periphery 10 to interlocking means 15. Stem 14 is adapted to flex during locking and unlocking of said interlocking elements 12.

Interlocking means 15 comprise either an interlocking means with a male mating portion 16 or a female mating portion 17. Said male interlocking means 16 comprises a sphere incorporating male mating portion 20, and said female interlocking means 17 comprises a sphere, on one side with a concavity or female locking portion 18, and on the other side a neutral mating portion 22, being substantially flat. It must be emphasized that neutral mating portion 22 is not essential to the functionality of the present invention. If there were no neutral mating portion 22, the invention would still work as designed, but it would be aesthetically less pleasing since there would be two interlocking means 15 on one side and two interlocking means 15 on the other side. With neutral mating portion 22, the four interlocking means 15 are aligned straight and evenly.

Tile body 4 also has a receiving cavity 28 substantially in its center, comprising a round hole adapted to receive and lock elongated connector 26 or short connector 30, as seen on FIG. 4. Said locking of elongated connector 26 or short connector 30 is accomplished by receiving cavity 28's female mating portion 29, adapted to receive a male mating portion 27 of elongated connector 26 or short connector 30, seen on FIG. 4.

FIG. 2 shows another embodiment of the present invention, wherein interlocking means 15 are not spherical but flattened, resembling clothing buttons. Interlocking portions 16 and 17 are configured identical to the embodiment in FIG. 1, with female mating portions 18 and male mating portions 20 intercooperating as described in FIG. 1.

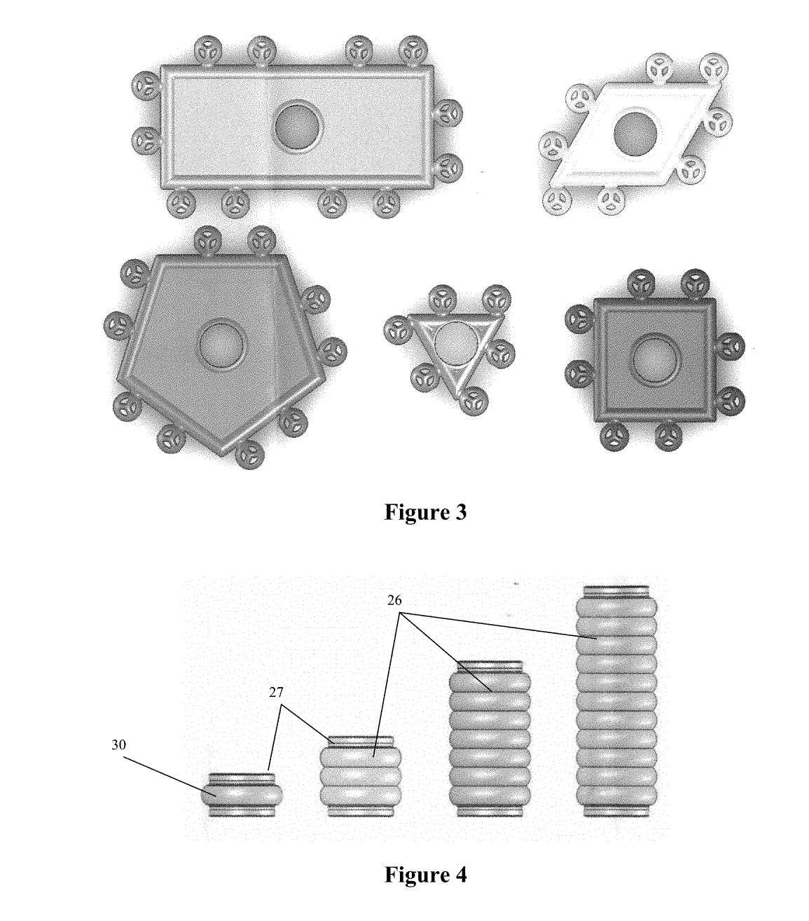

FIG. 3 demonstrates various embodiments of body 4 shapes that can be operably used for the present invention. Due to the fact that each side's interlocking means 15 is hermaphroditic, any shape can be joined to any other shape.

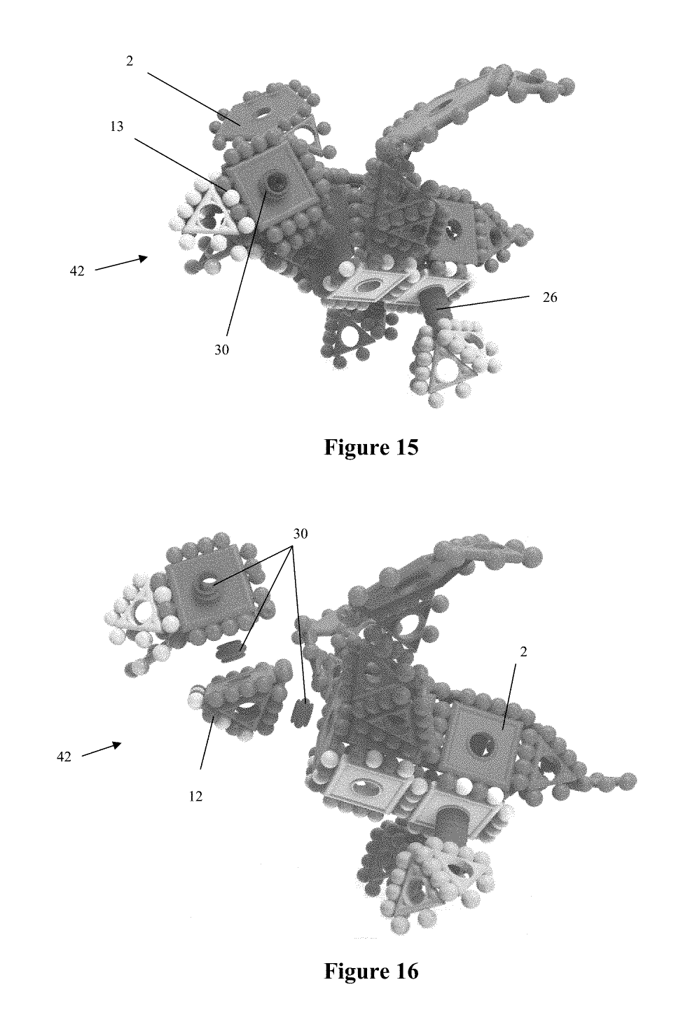

FIG. 4 shows elongated connectors 26 of various lengths, and short connector 30. Elongated connectors 26 and short connector 30 comprise a cylindrical body with male mating portions 27 on the ends. Short connector 30 is used to affix two tiles 2 in close proximity so that the two tiles 2 are stacked, to simulate a neck between a body and a head (as seen on FIGS. 15 and 16). The head will be able to rotate about the body. Short connector 30 can also serve as a cosmetic feature such as an eye of an animal, as seen on FIGS. 15 and 16.

Short connector 30 is also necessary if one tile 2 has all interlocking means 15 populated by other tiles 2, and the user needs a fresh tile 2 with all interlocking means 15 available for additional tiles 2. For example, if the user is making a model of a bird (see FIGS. 15 and 16), short connector 30 would connect the tile 2 that makes part of the bird's body to the tile 2 that makes part of the bird's head. This short connector 30 would allow the bird's head to rotate, similar to a real bird's range of motion.

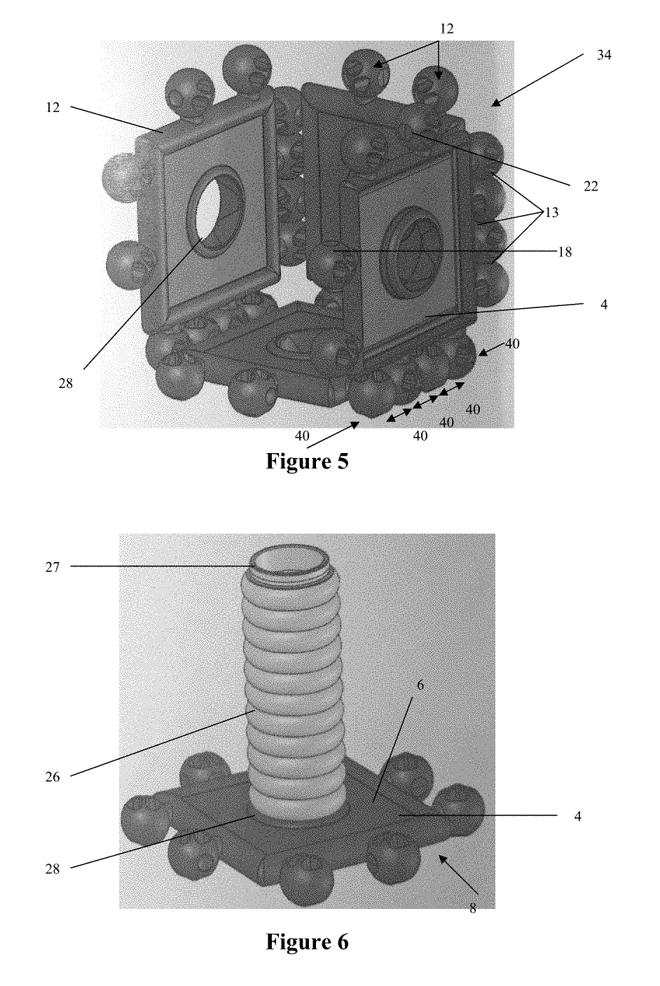

FIG. 5 shows a sample three-dimensional structure 34 comprising four tiles 2, wherein interlocking elements 12 around tile periphery 10 are interlocked with adjacent interlocking elements 12 between tiles 2. Male mating portions 20 cooperate with female mating portions 18 to provide a secure lock. Force vectors 40 retain interlocking elements 12 together. In the preferred embodiment, there are a minimum of two interlocking elements 12 on each tile periphery 10, said elements 12 are spaced so that there is a gap between them wide enough to accept an interlocking element 12 from another tile 2. In the resulting joint shown on FIG. 5, there are four elements 12, two being on the inside and two being on the outside of said joint. There are three points of contact 13 between the four elements 12. For the invention to function properly, there must be no gap or space between the middle point of contact 13, between the two inside elements 12. If there is any gap or space between points of contact 13, the invention will not work. This is particularly true if there is a gap between point of contact 13 between the two inside elements 12.

FIG. 6 shows elongated connector 26 inserted into elongated connector receiving cavity 28 in tile body's 4. It should be pointed out that cavity 28 can simultaneously accommodate two connectors 26, one connector 26 on top 6 and one connector 26 on the bottom 8 of tile body 4.

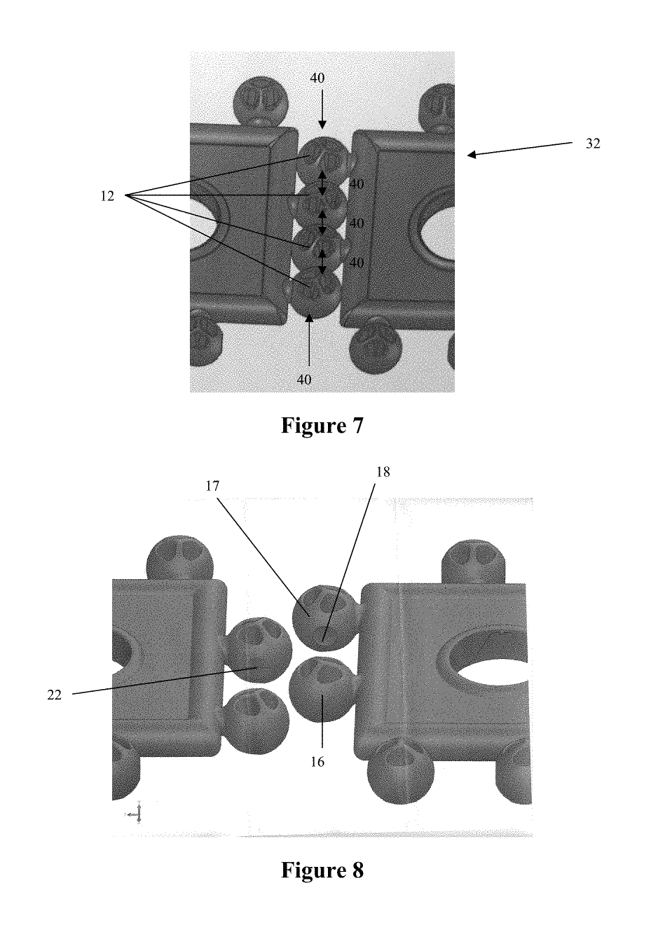

FIG. 7 shows a sample two-dimensional structure 32, with force vectors 40 exerting force on interlocking means 12, holding tiles 2 together.

FIG. 8 shows a second variant of the preferred embodiment, wherein male and female interlocking means 16 and 17 are swapped places. It should be noted that this second variant will work as well as the first variant.

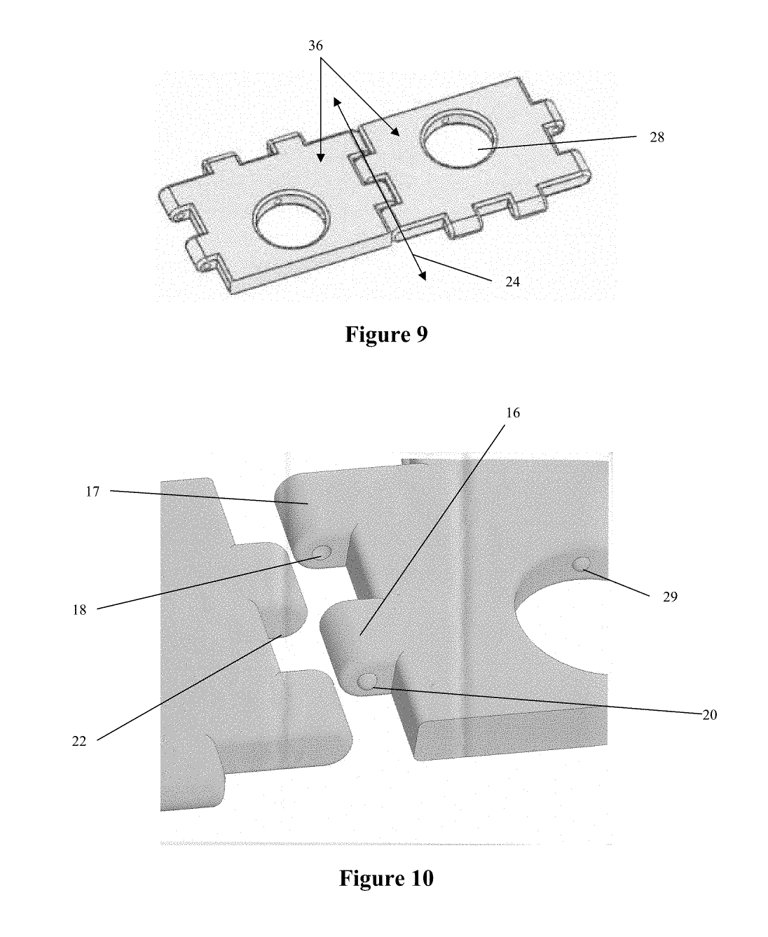

FIG. 9 shows another embodiment of the present invention, being a hinge-type tile 36. Tile 36 comprises interlocking elements 12 without stems 14, resembling hinge knuckles. As seen on FIG. 10, tile 36 also has female and male mating portions 18 and 20 on interlocking means with male mating portions 16 and female mating portions 17. As in the first embodiment, interlocking element with male mating portion 16 has a neutral mating portion 22. Cavity 28 receives elongated connector 26 or short connector 30 by means of female mating means 29 comprising protruding half-spheres inside cavity 28's circumference that lock elongated connector 26's or short connector 30's male mating means 27.

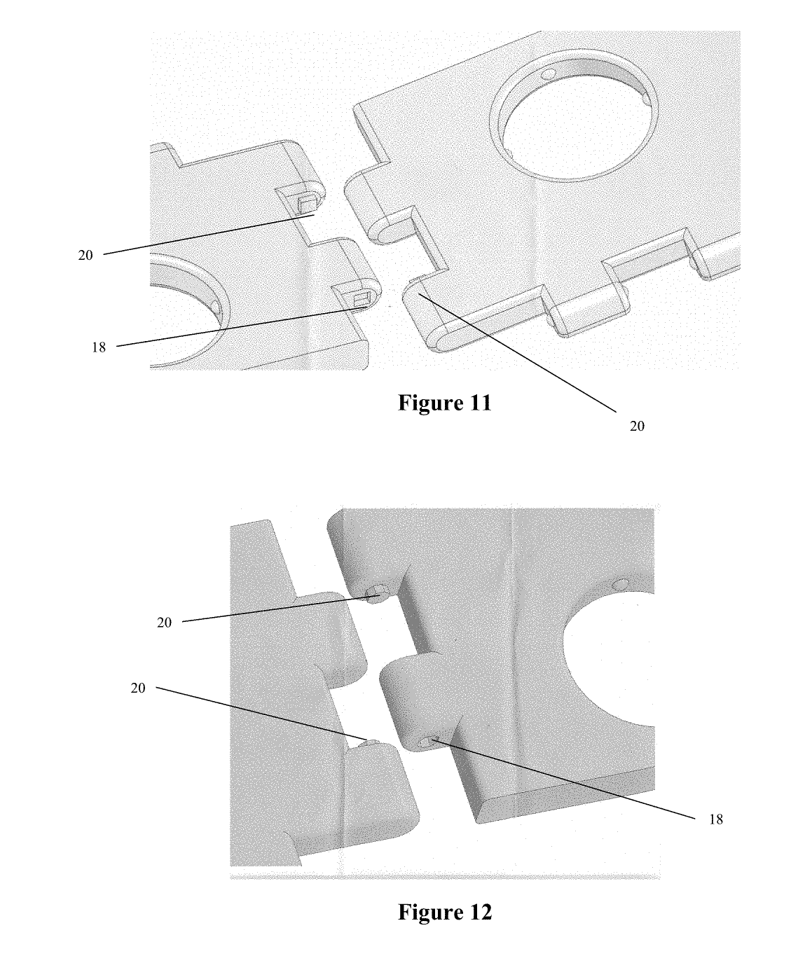

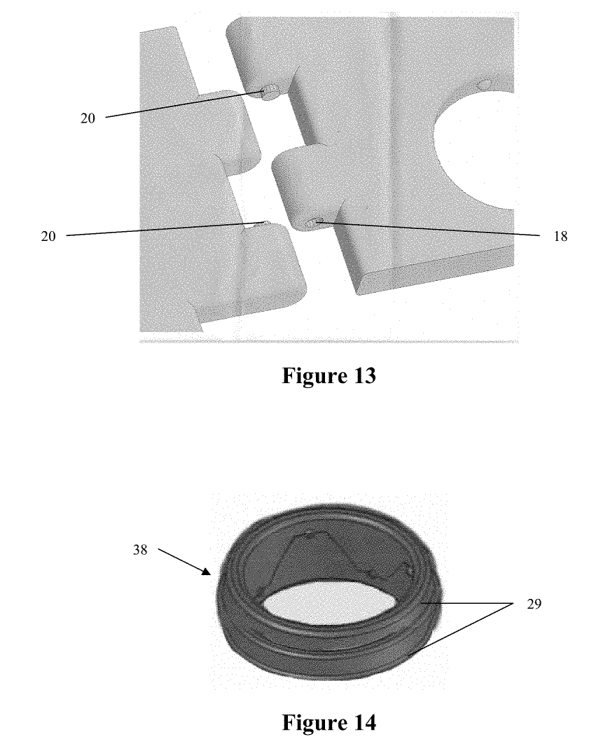

FIG. 11 demonstrates a variant in female and male mating portions 18 and 20, being of a square-walled configuration. This configuration allows the tiles to be positively locked at 90° and 180° rather than a fluid, axial connection 24 as seen on FIG. 9. FIG. 12 shows another variant of female and male mating portions 18 and 20 with octagonal walls, and FIG. 13 shows polygonal walls. It should be noted that the present embodiment of the positive locking variant is not restricted to the demonstrated variants, and is functional with any number of walls of the female and male mating portions 18 and 20 for a positive-locking intercooperation. It is also important to note that said positive locking variant can be incorporated on the first embodiment that is shown on FIGS. 1-8.

FIG. 14 shows an elongated connector expander 38 for customizing the length of elongated connectors 26 or short connectors 30, comprising a ring with a female connector 29 on each side for joining two elongated connectors 26 or short connectors 30 end to end. For example, if a user needs to create an elongated connector 26 of a specific length that is not provided, she can use expanders 38 and a plurality of elongated connectors 26 to create the desired length.

FIGS. 15 and 16 demonstrate a construction 42 of a bird out of tiles 2, elongated connectors 26 and short connectors 30. There are approximately sixty pieces in construction 42. Elongated connector 30 serves as both a neck connecting construction 42's head to body, as well as the eyes. Construction 42 can be animated to an identical degree as a real bird: the wings can pivot and be modeled as the child sees fit, the head can turn, the beak can open and close, and the legs can rotate.

As seen on FIG. 16, short connectors 30 permit adjacent placement of tiles 2 to expand a construction indefinitely. The body is connected to a neck, which is connected to a head. Said neck comprises one square tile 2 and four triangular tiles 2. All interlocking elements 12 cooperate to join together due to the hermaphroditic nature of the interlocking means 15.

It should be noted that in the present embodiments, the invention is inoperable unless there are a minimum of two interlocking elements 12 on each periphery 10 of tile 2, and tiles 2 will only interlock as long as tops 6 of each tile are oriented in the same plane. In the preferred embodiment, tiles 2 will not interlock if top 6 and bottom 8 are oriented in the same plane. In any resulting joint of four interlocking elements 12, there will always be two outside and two inside interlocking elements 12.

Regarding tile 36 of FIG. 10, since there is no stem 14 to flex during connection, it should be noted that the size of the male mating portion 20 is directly proportional to the flexibility of the material of manufacture for tile 36. For example, if tile 36 is made of a very stiff plastic, male mating portion 20 is relatively small to permit interlocking elements 12 to lock. However, if tile 36 is made of very flexible foam, male mating portion 20 should be substantially larger so as not to slip out after mating with female mating portion 20 due to the material's pliant nature. The same principle applies to the embodiment shown on FIGS. 1-8.

In operation, referring to FIGS. 1-8, user positions tiles 2 so that tops 6 are both in the same plane, and moves interlocking elements 12 towards each other so that female interlocking elements 17 are between male interlocking elements 16. Once interlocking means 15 from two adjoining tiles 2 abut each other, user pushes tiles 2 together so that convex male mating portions 20 on interlocking means 16 slip into concave female mating portions 18 on interlocking means 17. Interlocking elements 12 will flex slightly on stems 14 to permit interlocking means 16 to overcome resilient resistance of interlocking means 17, and seat male mating portion 20 securely into female mating portion 18.

The resulting lock permits one tile 2 to rotate about an axis 24 with said second tile 2, thus allowing building of two- or three-dimensional structures. User can insert elongated connectors 26 or short connectors 30 into receiving cavities 28 on either the top 6, bottom 8, or both top and bottom 6 and 8 to expand the 2D or 3D construction 32 or 34.

Referring to FIGS. 9-13, user aligns tiles 36 so that tops 6 are in the same plane, and pushes tiles 36 together so that interlocking elements 12 interconnect, the interlocking means with male mating portion 16 is directly adjacent to the interlocking means with female mating portion 17. User pushes tiles 36 together until male mating portion 20 locks within female mating portion 18. Depending on the variant, the resulting joint will be axial 24 (see FIG. 9) or a positive lock without any rotation about the joint's axis.

Force vectors 40 keep the resulting joint from loosening due to the fact that one vector 40 is applied inwardly on the joint by one tile 2's outside interlocking element 12, and another vector 40 is being applied in the opposite direction on the joint by the other tile 2's outside interlocking element 12.

1. Construction toy structure with interlocking elements comprising:
a plurality of tile-shaped elements of generally flat configuration, each of said tile-shaped elements has a top, a bottom and periphery sides surrounding said tile-shaped element;
each of said tile-shaped elements is provided with at least two interlocking elements connected to each side of said tile-shaped elements;
wherein one of said interlocking elements is provided with a male mating portion and another of said interlocking element is provided with a female mating portion;
wherein said male and said female mating portions of said interlocking elements located on the side of one of said tile-shaped elements is adapted to cooperate with a corresponding male and female mating portions of said interlocking elements located on the side of another tile-shaped elements to be securely locked with each other to form a construction of desired shape;
wherein interlocked tile-shaped elements are adapted to form two-dimensional and three-dimensional structures by means of rotating said interlocked tile-shaped elements in any desired direction,
and wherein each of said tile-shaped elements must be oriented in the same plane to facilitate proper interlocking of said construction toy structure.

2. Construction toy structure with interlocking elements according to claim 1, wherein each of said interlocking elements comprises a sphere shape configuration on a stem of a cylindrical configuration, said stem is connected to the side of said tile-shaped element.

3. Construction toy structure with interlocking elements according to claim 2, wherein one of said interlocking elements on one side of said tile-shaped element contains a male mating portion of a sphere-shaped configuration and said second interlocking element on said side contains a female mating portion having a concavity formed on one side of said interlocking element, wherein said sphere-shaped male mating portion of said interlocking element is adapted to cooperate with the concavity of the female mating portion of the interlocking element located on the side of another tile-shaped element to securely lock said tile-shaped elements together.

4. Construction toy structure with interlocking elements according to claim 2, wherein said stems of said interlocking elements are adapted to flex during locking and unlocking of said tile-shaped elements.

5. Construction toy structure with interlocking elements according to claim 1, wherein each of said tile-shaped elements is provided with a cavity located in a center of said tile-shaped elements, said cavity is provided to receive connectors of various lengths.

6. Construction toy structure with interlocking elements according to claim 1, wherein each of said interlocking elements has a flat, round configuration,
wherein one of said interlocking elements on one side of said tile-shaped elements is provided with a male mating portion of spherical configuration, and another of said interlocking elements on said side has a female mating portion of concave configuration,
said interlocking elements are connected to said tile-shape element by means of cylindrical stems,
wherein said stems are adapted to flex during locking and unlocking of said tile-shaped elements.

7. Construction toy structure with interlocking elements according to claim 1, wherein each of said interlocking elements located on one side of said tile-shaped element has a configuration of a hinge knuckle, wherein one of said hinge knuckle-shaped interlocking elements is provided with a male mating portion and another of said hinge knuckle-shaped interlocking elements on said side is provided with a female mating portion.

8. Construction toy structure with interlocking elements according to claim 7, wherein said male mating portion has a square configuration and wherein said female mating portion has a square cavity configuration.

9. Construction toy structure with interlocking elements according to claim 7, wherein said male mating portion has an octagonal configuration and wherein said female mating portion has an octagonal cavity configuration.

9. Construction toy structure with interlocking elements according to claim 7, wherein said male mating portion has a polygonal configuration and wherein said female mating portion has a polygonal cavity configuration.

10. Construction toy structure with interlocking elements according to claim 3, wherein each of said interlocking elements containing female mating portion comprises a neutral mating portion located on opposite side of said concavity formed on said female mating portion.

11. Construction toy structure with interlocking elements according to claim 1, wherein each of said tile-shaped elements has a square configuration.

12. Construction toy structure with interlocking elements comprising:
a plurality of tile-shaped elements of generally flat configuration, each of said tile-shaped elements has a top, a bottom and periphery sides surrounding said tile-shaped element;
each of said tile-shaped elements is provided with at least two interlocking elements connected to each side of said tile-shaped elements;
wherein one of said interlocking elements on each side is provided with a male mating portion and another of said interlocking elements on said side is provided with a female mating portion;
wherein said male and said female mating portions are adapted to cooperate with corresponding male and female mating portions on the side of another tile-shaped element to securely lock said tile-shaped elements together to form a construction of desired shape;
wherein interlocked tile-shaped elements are adapted to form two-dimensional and three-dimensional structures by means of rotating of said interlocked tile-shaped elements in any desired direction;
wherein each of said tile-shaped elements must be oriented in the same plane to facilitate proper assembly of said construction toy structure; and
wherein each of said tile-shaped elements is provided with a cavity located in a center of said tile-shaped elements, said cavity is adapted to receive connectors of various lengths.

13. Construction toy structure with interlocking elements according to claim 12, wherein each of said interlocking elements comprises a sphere shape configuration on a stem of a cylindrical configuration, said stem is connected to the side of said tile-shaped element.

14. Construction toy structure with interlocking elements according to claim 13, wherein one of said interlocking elements contains a male mating portion of a sphere-shaped configuration formed on one side of said interlocking element, and said second interlocking element contains a female mating portion having a concavity formed on one side of said interlocking element, wherein said sphere-shaped male mating portion of said interlocking element is adapted to cooperate with the concavity of the female mating portion of the interlocking element located the side of another tile-shaped element to securely lock said tile-shaped elements together.

15. Construction toy structure with interlocking elements according to claim 13, wherein said stems of said interlocking elements are adapted to flex during locking and unlocking of said tile-shaped elements.

16. Construction toy structure with interlocking elements according to claim 12, wherein each of said interlocking elements has a flat, round configuration,
wherein one of said interlocking elements on one side of said tile-shaped elements is provided with a male mating portion of spherical configuration, and another of said interlocking elements on said side has a female mating portion of concave configuration,
said interlocking elements are connected to said tile-shape element by means of cylindrical stems,
wherein said stems are adapted to flex during locking and unlocking of said tile-shaped elements.

17. Construction toy structure with interlocking elements according to claim 12, wherein each of said interlocking elements located on one side of said tile-shaped element has a configuration of a hinge knuckle, wherein one of said hinge knuckle-shaped interlocking elements is provided with a male mating portion and another of said hinge knuckle-shaped interlocking elements on said side is provided with a female mating portion.

18. Construction toy structure with interlocking elements according to claim 17, wherein said male mating portion has a square configuration and wherein said female mating portion has a square cavity configuration.

19. Construction toy structure with interlocking elements according to claim 17, wherein said male mating portion has an octagonal configuration and wherein said female mating portion has an octagonal cavity configuration.

20. Construction toy structure with interlocking elements according to claim 17, wherein said male mating portion has a polygonal configuration and wherein said female mating portion has a polygonal cavity configuration.

21. Construction toy structure with interlocking elements according to claim 14, wherein each of said interlocking elements containing female mating portion comprises a neutral mating portion located on opposite side of said concavity formed of said female mating portion.

22. Construction toy structure with interlocking elements according to claim 12, wherein each of said tile-shaped elements has a square configuration.
